(19) United States
(12) Patent Application Publication
(10) Pub. No.: US 2009/0109058 A1
(43) Pub. Date: Apr. 30, 2009

(54) Traffic information providing method and device and traffic information receiving method and device

(75) Inventors: Kyu hyung KIM, Dalseo-gu (KR); Jang sik BAE, Daegu (KR); Gwang Su KIM, Daejeon (KR); Kee Koo KWON, Daegu (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/149,678

(22) Filed: May 6, 2008

(30) Foreign Application Priority Data
Oct. 24, 2007 (KR) 10-2007-0107110

(51) Int. Cl. G08G 1/09; G09F 9/00

(52) U.S. Cl. 340/905; 340/995.13; 701/117

(57) ABSTRACT

The traffic information providing device receives traffic information corresponding to a bus stop or a platform at which the traffic information providing device is positioned from a management server for collecting traffic information from at least one public transportation means, and broadcasts the received traffic information to the traffic information receiving device that is provided within a predetermined distance from the traffic information providing device by using the ZigBee or wireless sensor network that is a wireless personal area network (WPAN). The traffic information receiving device receives traffic information from the traffic information providing device by using the ZigBee or wireless sensor network, filters the same according to a filtering condition input by the user, and outputs traffic information desired by the user.

### CROSS-REFERENCE TO RELATED APPLICATION

This application claims priority to and the benefit of Korean Patent Application No. 10-2007-0107110 filed in the Korean Intellectual Property Office on Oct. 24, 2007, the entire contents of which are incorporated herein by reference.

### BACKGROUND OF THE INVENTION

(a) Field of the Invention

The present invention relates to a traffic information providing method and device and a traffic information receiving method and device. More particularly, the present invention relates to a traffic information providing method and device for providing traffic information of public transportation means, and a traffic information receiving method and device for receiving traffic information of public transportation means and providing the traffic information to a user.

(b) Description of the Related Art

In order to provide traffic information of public transportation means to public transportation users in the prior art, the current position of a bus or a subway that is public transportation means is collected by using a GPS receiver. In the case of a bus, current position information of the bus is transmitted to a management server through a code division multiple access (CDMA) module installed in the bus, and the management server collects the current position information of each bus through CDMA communication. The collected information is transmitted to a bus information providing device provided at a specific bus stop through various communication methods such as a local area network (LAN), a wide local area network (WLAN), and CDMA, and the bus information providing device outputs the traffic information to persons standing at the bus stop through text or voice.

The above-noted conventional traffic information providing method sequentially notifies the bus information providing device installed at the bus stop of an arrival time of a predetermined bus, and provides common traffic information to many persons other than specific users. Also, the user desiring to use bus information can check the information when he stands before the bus information providing device. In the case of the subway, the user can know the direction of a coming train when he approaches the subway platform, and hence the user standing in the station other than at the platform cannot check the current subway information.

Regarding another conventional method for providing traffic information to the public transportation user, when the user uses a terminal such as a mobile phone to transmit identification information, destination, and departure of the desired public transportation means to the management server, the management server extracts traffic information that corresponds to the condition input by the user from among the collected traffic information and transmits the extracted traffic information to the user. The traffic information providing method increases the operating volume of the management server when many users simultaneously require traffic information. Also, the user must inconveniently input departure information together with destination or public transportation means identification information so as to acquire desired traffic information.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a traffic information providing method and device for efficiently providing traffic information to the user and a traffic information receiving method and device for receiving specific traffic information desired by the user and providing the specific traffic information to the user.

In one aspect of the present invention, a method for receiving traffic information by a traffic information receiving device that is provided within a predetermined distance from a traffic information providing device that is installed at a predetermined position on the route of predetermined public transportation means includes: receiving traffic information on the predetermined public transportation means from the traffic information providing device through a wireless personal area network; receiving a filtering condition; extracting predetermined traffic information from the traffic information based on the filtering condition; and outputting the extracted specific traffic information.

In another aspect of the present invention, a method for providing traffic information by a traffic information providing device that is provided at a predetermined position on the route of predetermined public transportation means includes: receiving the traffic information from a management server for collecting traffic information from the predetermined public transportation means; and broadcasting the traffic information through a wireless personal area network.

In another aspect of the present invention, a traffic information receiving device provided within a predetermined distance from a traffic information providing device that is installed at a predetermined position on the route of a predetermined public transportation means includes: a receiver for receiving traffic information of the predetermined public transportation means from the traffic information providing device through a wireless personal area network; an input unit for receiving a filtering condition; a filter for extracting predetermined traffic information from the traffic information based on the filtering condition; and an output unit for outputting the extracted traffic information as at least one format of text, voice, and image.

In another aspect of the present invention, a traffic information providing device provided at a predetermined position on the route of predetermined public transportation means includes: a receiver for receiving the traffic information from a management server for collecting traffic information of the predetermined public transportation means; and a transmitter for broadcasting the traffic information by using a wireless personal area network.

According to the exemplary embodiment of the present invention, when the traffic information is provided to each user through broadcasting by using the wireless personal area network such as a ZigBee or wireless sensor network, the user can check the traffic information at any position in the bus stop or the station without standing before the traffic information providing device. Also, the user can efficiently acquire desired information since it is possible to set the traffic information receiving device so as to extract information such as a specific bus or a specific subway from among broadcast traffic information.

### BRIEF DESCRIPTION OF THE DRAWINGS

FIG. 1 shows a ZigBee or wireless sensor network for providing bus traffic information according to an exemplary embodiment of the present invention.

FIG. 2 shows a ZigBee or wireless sensor network for providing subway traffic information according to an exemplary embodiment of the present invention.

FIG. 3 is a configuration diagram for a traffic information providing device according to an exemplary embodiment of the present invention.

FIG. 4 is a configuration diagram for a traffic information receiving device according to an exemplary embodiment of the present invention.

FIG. 5 is a flowchart for a traffic information providing method by a traffic information providing device according to an exemplary embodiment of the present invention.

FIG. 6 is a flowchart for a traffic information receiving method by a traffic information receiving device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” and variations such as “comprises” will be understood to imply the inclusion of stated elements but not the exclusion of any other elements. Also, the terms of a unit, a device, and a module in the present specification represent a unit for processing a predetermined function or operation, which can be realized by hardware, software, or a combination of hardware and software.

A traffic information providing device and traffic information receiving device according to an exemplary embodiment of the present invention will now be described with reference to the accompanying drawings.

Here, the traffic information includes at least one of an expected arrival time of public transportation means (including a bus or a train) at a bus stop or a platform, and current position thereof.

A ZigBee or wireless sensor network will be exemplified in order for a traffic information providing device and a traffic information receiving device to transmit and receive traffic information, and other types of wireless personal area networks (WPAN) are also applicable to the present invention.

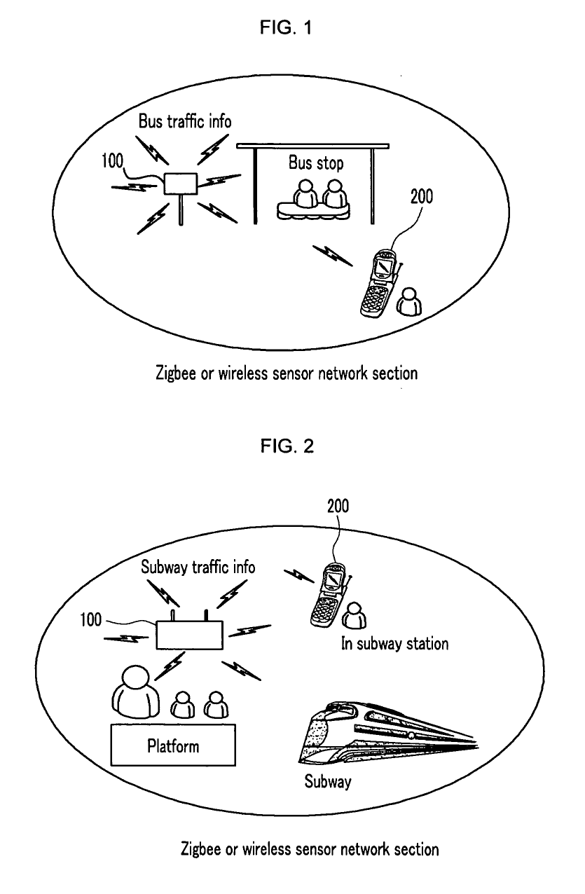

FIG. 1 and FIG. 2 respectively show a ZigBee or wireless sensor network according to an exemplary embodiment of the present invention, and in detail, FIG. 1 is a ZigBee or wireless sensor network for providing bus traffic information according to an exemplary embodiment of the present invention, and FIG. 2 is a ZigBee or wireless sensor network for providing subway traffic information according to an exemplary embodiment of the present invention.

Referring to FIG. 1, a traffic information providing device 100 for providing bus traffic information is installed at a bus stop, and receives traffic information from a management server (not shown) for collecting traffic information from the bus and controlling the same, through various communication methods. The received traffic information includes current positions of the buses passing through the bus stop at which the traffic information providing device 100 is installed, and expected arrival times of the buses. The received bus traffic information is broadcast to a traffic information receiving device 200 near the bus stop by using the ZigBee or wireless sensor network technique.

The traffic information receiving device 200 receives bus traffic information from the traffic information providing device 100, filters the traffic information according to various conditions input by the user, and provides specific traffic information to the user. For example, when the user inputs a specific bus number, the traffic information receiving device 200 extracts traffic information of the corresponding bus and provides the traffic information to the user.

The traffic information receiving device 200 provides traffic information to the user in the format of voice, text, or image. Here, the traffic information receiving device 200 is a terminal that is possessed by the user who desires to use the bus, and can have various forms such as a mobile phone or a bracelet.

Referring to FIG. 2, the traffic information providing device 100 receives subway traffic information from the management server (not shown) and broadcasts the subway traffic information in a like manner of the bus. The traffic information providing device 100 is installed in the subway platform or station, and broadcasts subway traffic information to the traffic information receiving device 200 of the users staying in the station by using the ZigBee or wireless sensor network. In this instance, the subway traffic information includes the current position of a train that passes through the subway station in which the traffic information providing device 100 is provided.

The traffic information receiving device 200 filters the traffic information provided by the traffic information providing device 100 and provides the filtered information to the user in a like manner of receiving bus traffic information. For example, when the user inputs a specific destination, the traffic information receiving device 200 extracts traffic information of the train that leaves for the corresponding destination, and provides the traffic information to the user.

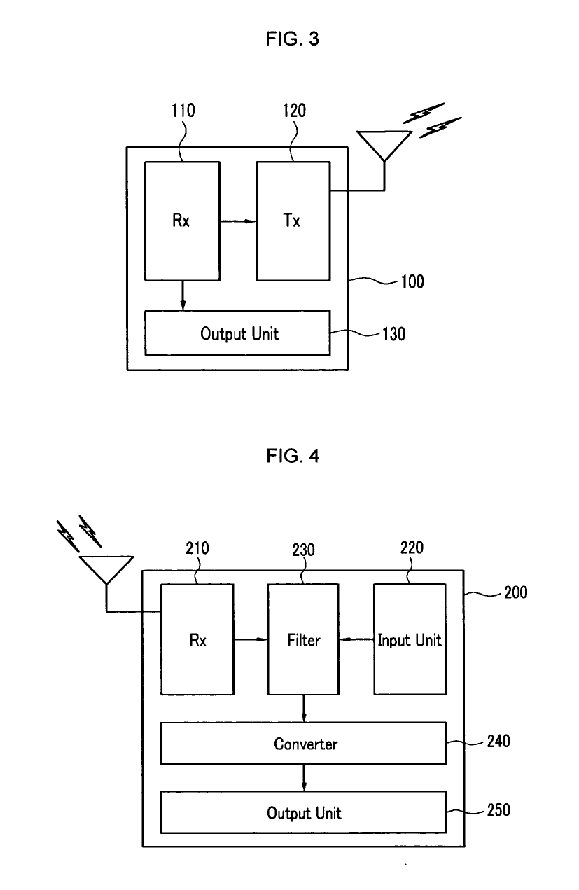

FIG. 3 shows the traffic information providing device 100 according to an exemplary embodiment of the present invention, and the traffic information providing device 100 can be installed at specific positions on the routes of specific public transportation means, that is, at the bus stop, at the subway platform, or in the station.

Referring to FIG. 3, the traffic information providing device 100 includes a receiver 110, a transmitter 120, and an output unit 130.

The receiver 110 receives traffic information of specific public transportation means passing through a specific position at which the traffic information providing device 100 is installed from the management server (not shown). Here, the receiver 110 uses the communication methods including LAN, WLAN, and CDMA so as to receive traffic information from the management server.

The transmitter 120 establishes a ZigBee or wireless sensor network channel with the traffic information receiving device 200. That is, the transmitter 120 broadcasts on the ZigBee or wireless sensor network channel for broadcasting traffic information, and the traffic information receiving device 200 having received the ZigBee or wireless sensor network channel broadcast receives the traffic information through the corresponding channel. The transmitter 120 periodically broadcasts the traffic information received through the receiver 110 to at least one traffic information receiving device 200 that is positioned within a predetermined distance from the traffic information providing device 100. The transmitter 120 uses the ZigBee or wireless sensor network to broadcast the traffic information.

The output unit 130 outputs the traffic information received through the receiver 110 by using the text, image, and voice.

FIG. 4 shows the traffic information receiving device 200 according to an exemplary embodiment of the present invention, and the traffic information receiving device 200 receives traffic information from the traffic information providing device 100 that is positioned at a bus stop or a platform within a predetermined distance from the traffic information receiving device 200.

Referring to FIG. 4, the traffic information receiving device 200 represents a user terminal, and includes a receiver 210, an input unit 220, a filter 230, a converter 240, and an output unit 250.

The receiver 210 establishes the ZigBee or wireless sensor network based on ZigBee or wireless sensor network channel information broadcast by the traffic information providing device 100, and periodically receives traffic information of specific public transportation means.

The input unit 220 receives a filtering condition from the user, and transmits the filtering condition to the filter 230. The input filtering condition includes at least one of destination information and corresponding public transportation means identification information. Since the traffic information providing device 100 provides traffic information corresponding to the user's current position, the user can check desired traffic information by inputting destination or identification information without inputting destination information.

The filter 230 filters the received traffic information based on the filtering condition and extracts specific traffic information corresponding to the user request.

The converter 240 converts the specific traffic information that is filtered and extracted by the filter 230 into a desired output format. For example, the converter 240 converts the received data into the voice format when desiring to provide the specific traffic information as voice. The converter 240 can also receive the desired output format from the user through the input unit 220, and output the same in the received format.

A traffic information providing method and a traffic information receiving method according to an exemplary embodiment of the present invention will now be described with reference to drawings.

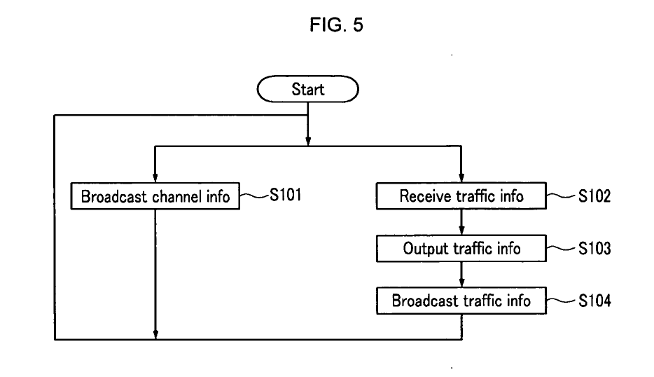

FIG. 5 is a flowchart for the traffic information providing device 100 according to an exemplary embodiment of the present invention to provide traffic information.

Referring to FIG. 5, the traffic information providing device 100 broadcasts information on the ZigBee or wireless sensor network channel for broadcasting the traffic information (S101). The channel information is periodically broadcast for the traffic information receiving devices 200 that are newly connected to the corresponding ZigBee or wireless sensor network.

On receiving traffic information from the management server (S102), the traffic information providing device 100 outputs the received traffic information in the format of voice, text, and images (S103), and broadcasts the traffic information by using the ZigBee or wireless sensor network so as to transmit the traffic information to the traffic information receiving device 200 (S104).

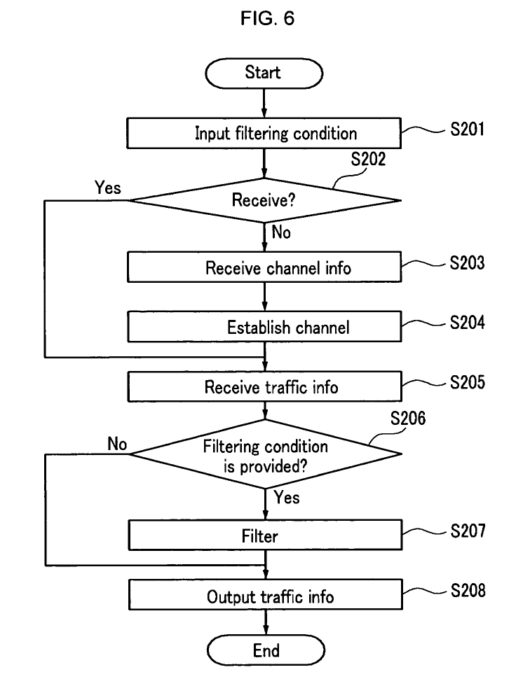

FIG. 6 is a flowchart for the traffic information receiving device 200 according to an exemplary embodiment of the present invention to receive traffic information.

Referring to FIG. 6, when the user requests traffic information provision, the traffic information receiving device 200 determines whether the ZigBee or wireless sensor network channel with the traffic information providing device 100 is established and if it is possible to receive traffic information (S202). When the user desires specific traffic information, the traffic information receiving device 100 can receive a filtering condition for extracting specific traffic information from the user (S201).

When the ZigBee or wireless sensor network channel with the traffic information providing device 100 is not established and the traffic information cannot be received, the traffic information receiving device 200 receives the channel information broadcast by the traffic information providing device 100 (S203), and establishes the ZigBee or wireless sensor network channel with the traffic information providing device 100 based on the received channel information (S204).

When the channel is established, the traffic information receiving device 200 receives traffic information broadcast by the traffic information providing device 100 (S205).

When there is a filtering condition input by the user (S206), the traffic information receiving device 200 filters the traffic information according to the filtering condition to extract traffic information corresponding to the specific condition (S207). For example, when the user inputs the destination as a filtering condition, the traffic information receiving device 200 extracts information of transportation means corresponding to the input destination.

The traffic information receiving device 200 outputs the traffic information provided by the traffic information providing device 100 or the filtered traffic information to the user (S208). In this instance, the traffic information is converted into the format of text, voice, and image to be provided, and can also be converted into other formats desired by the user.

When the traffic information is provided to the user by using the ZigBee or wireless sensor network, the user can efficiently receive the traffic information since there is no need for the user to stand before the traffic information providing device 200 so as to check the traffic information output by the traffic information providing device 200.

Also, when traffic information on all the transportation means corresponding to the bus stop or the platform at which the traffic information providing device 100 is installed is broadcast, the traffic information receiving device 200 can extract information including a specific bus and a specific subway according to the user's input so that the user may efficiently acquire desired information.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for receiving traffic information by a traffic information receiving device that is provided within a predetermined distance from a traffic information providing device that is installed at a predetermined position on a route of predetermined public transportation means, the method comprising:
receiving traffic information on the predetermined public transportation means from the traffic information providing device through a wireless personal area network;
receiving a filtering condition;
extracting predetermined traffic information from the traffic information based on the filtering condition; and
outputting the extracted specific traffic information.

2. The method of claim 1, further comprising:
determining whether the wireless personal area network with the traffic information providing device is established;
receiving channel information on the wireless personal area network broadcast by the traffic information providing device when the wireless personal area network is not established; and
establishing the wireless personal area network based on the channel information.

3. The method of claim 1, wherein
the filtering condition includes at least one of destination information and public transportation means identification information.

4. The method of claim 1, wherein
the wireless personal area network is a ZigBee or wireless sensor network.

5. A method for providing traffic information by a traffic information providing device that is provided at a predetermined position on a route of predetermined public transportation means, the method comprising:
receiving the traffic information from a management server for collecting traffic information from the predetermined public transportation means; and
broadcasting the traffic information through a wireless personal area network.

6. A traffic information receiving device provided within a predetermined distance from a traffic information providing device that is installed at a predetermined position on a route of a predetermined public transportation means, the traffic information receiving device comprising:
a receiver for receiving traffic information of the predetermined public transportation means from the traffic information providing device through a wireless personal area network;
an input unit for receiving a filtering condition;
a filter for extracting predetermined traffic information from the traffic information based on the filtering condition; and
an output unit for outputting the extracted traffic information as at least one format of text, voice, and image.

7. The traffic information receiving device of claim 6, wherein
the filtering condition includes at least one of destination information and public transportation means identification information.

8. A traffic information providing device provided at a predetermined position on a route of predetermined public transportation means, the traffic information providing device comprising:
a receiver for receiving the traffic information from a management server for collecting traffic information of the predetermined public transportation means; and
a transmitter for broadcasting the traffic information by using a wireless personal area network.

9. The traffic information providing device of claim 8, wherein
the transmitter periodically broadcasts channel information of the wireless personal area network.
